(19) United States
(12) Patent Application Publication
(10) Pub. No.: US 2017/0241182 A1
(43) Pub. Date: Aug. 24, 2017

(54) COLLISION AVOIDANCE DEVICE AND METHOD FOR AVOIDING COLLISION WITH AN OBJECT IN A DOOR ZONE OF A VEHICLE

(71) Applicant: Shun-Ho Hung, Erlin Township (TW)

(72) Inventor: Shun-Ho Hung, Erlin Township (TW)

(21) Appl. No.: 15/050,059

(22) Filed: Feb. 22, 2016

(51) Int. Cl. E05F 15/41; E05F 15/46; E05F 15/73; B60J 5/04; E05F 15/78

(52) U.S. Cl. CPC E05F 15/41; B60J 5/047; E05F 15/78; E05F 15/73; E05F 15/46

(57) ABSTRACT

A collision avoidance device for avoiding collision with an object in a door zone of a vehicle, including a sensing module, a damping module and a control unit. Upon detecting an object moving toward a door of the vehicle, the sensing module calculates a velocity of the object. The control unit controls the damping module to apply a resistance force to a pivot unit that pivots the door for enabling the door to rotate at most at an initial rotational speed without detection of an object, a first rotational speed slower than the initial rotational speed when the velocity is smaller than a predetermined value, or a second rotational speed slower than the first rotational speed when the velocity is greater than the predetermined value.

### FIELD

The disclosure relates to a collision avoidance device and method, and more particularly to a collision avoidance device and method for avoiding collision with an object in a door zone of a vehicle.

### BACKGROUND

Referring to Taiwanese utility model patent No. M484527, a door-opening collision prevention alarm apparatus is embedded in a door of a vehicle and is configured to warn an object coming from a rear side of the vehicle by a warning light module. However, the warning light module can only warn the object coming from the rear side of the vehicle when the door is opened. The object coming from the rear side of the car may still collide with the door that is suddenly opened, and thus the effect for avoiding collision is limited.

Referring to Taiwanese utility model patent No. M491598, a detection/alarm device includes a detecting unit mounted on a rear part of a vehicle for detecting an object approaching the rear part of the vehicle, and a lock unit mounted on a door of the vehicle and configured to lock the door when the detecting unit detects an object approaching the rear part of the vehicle. However, the door would be locked and unable to be opened for a long period of time when many objects successively approach the rear part of the vehicle.

Referring to Taiwanese utility model patent No. M495980, a two-stage safety opening device for a door of a vehicle includes a detecting unit and a logic circuit cooperating to detect an object approaching a rear part of the vehicle, and a stop unit allowing the door to be opened in two stages. The stop unit allows the door to be opened only by a small angle in a first stage, and further allows the door to be completely opened in a second stage when it is determined that there is no object approaching the rear part of the vehicle. Similarly, the door cannot be opened beyond the small angle in the first stage and cannot be completely opened when many objects successively approach the rear part of the vehicle.

Referring to Taiwanese utility model patent No. M498695, an alarm safety system is for delayed opening of a door of a vehicle, and includes a handle for generating a trigger signal upon being touched, a timer for counting down a delay time in response to receiving the trigger signal, and a motion unit for stopping the door from being opened during the delay time and for allowing the door to be completely opened when the delay time has elapsed. However, the motion unit may apply an impact force to the door when a user intends to open the door suddenly during the delay time, and thus, the structure of the door may be broken after long-term usage.

### SUMMARY

Therefore, an object of the disclosure is to provide a collision avoidance device that can alleviate at least one of the drawbacks of the prior art.

According to the disclosure, the collision avoidance device is for avoiding collision with an object in a door zone of a vehicle. The vehicle includes a vehicle body, a door disposed at one side of the vehicle body, and a pivot unit connecting the door pivotally to the vehicle body. The collision avoidance device includes a sensing module, a damping module and a control unit.

The sensing module is configured to be disposed at the vehicle, and is operable to output a door-opened signal when the door is opened. The sensing module is further operable, upon detecting an object moving toward the door in a sensing range thereof, to calculate a velocity of the object and to output a velocity signal indicating the velocity of the object.

The damping module is configured to be disposed at the vehicle, and is operable to apply one of a first resistance force and a second resistance force greater than the first resistance force to the pivot unit.

The control unit is electrically connected to the sensing module and the damping module. The control unit is operable to control the damping module such that the damping module does not apply the first and second resistance forces to the pivot unit for enabling the door to rotate at most at an initial rotational speed without interference from the damping module when the control unit receives only the door-opened signal from the sensing module.

The control unit is operable to control the damping module to apply the first resistance force to the pivot unit for enabling the door to rotate at most at a first rotational speed slower than the initial rotational speed when the control unit receives the door-opened signal and the velocity signal from the sensing module and determines that the velocity of the object is smaller than a predetermined value according to the velocity signal.

The control unit is operable to control the damping module to apply the second resistance force to the pivot unit for enabling the door to rotate at most at a second rotational speed slower than the first rotational speed when the control unit receives the door-opened signal and the velocity signal from the sensing module and determines that the velocity of the object is greater than the predetermined value according to the velocity signal.

### BRIEF DESCRIPTION OF THE DRAWINGS

Other features and advantages of the disclosure will become apparent in the following detailed description of the embodiment with reference to the accompanying drawings, of which:

FIG. 1 is a block diagram of an embodiment of a collision avoidance device according to the disclosure;

FIG. 2 is a perspective partial view of a vehicle for illustrating an embodiment of a sensing module of the collision avoidance device disposed at a door of the vehicle according to the disclosure;

FIG. 3 is a schematic partial diagram of the vehicle for illustrating an embodiment of a damping module connected to a pivot unit of the vehicle according to the disclosure;

FIG. 4 is a schematic top view of the vehicle for illustrating an object approaching the vehicle;

FIG. 5 is a flow chart of a method for avoiding collision according to the disclosure; and

FIG. 6 is a schematic partial diagram of the vehicle for illustrating another embodiment of the damping module according to the disclosure.

### DETAILED DESCRIPTION

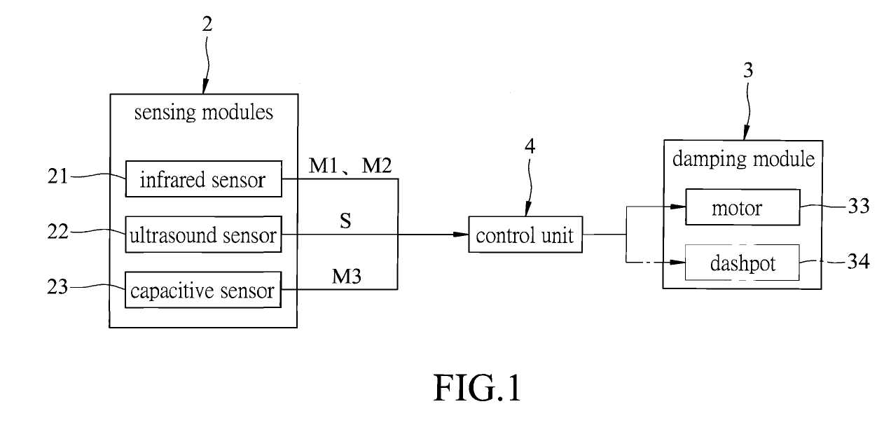

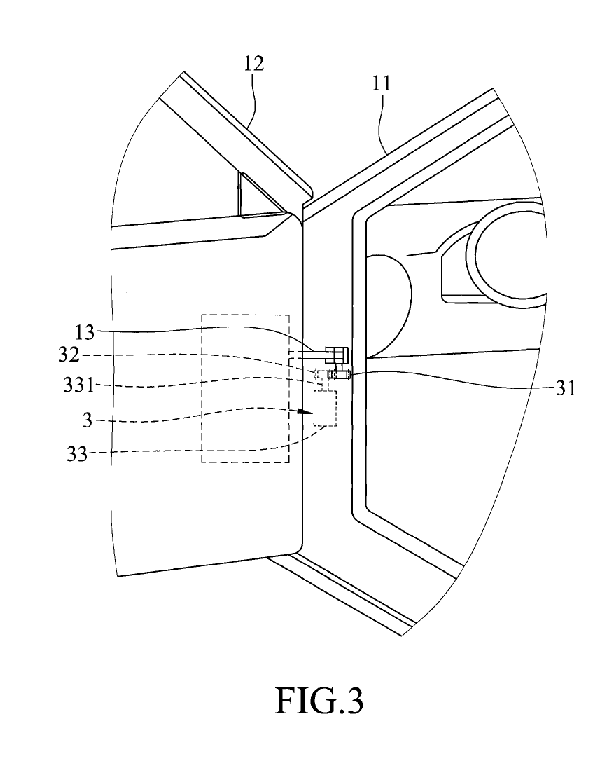

Referring to FIGS. 1 to 4, the embodiment of a collision avoidance device for avoiding collision with an object in a door zone of a vehicle 1 according to this disclosure is mounted on the vehicle 1. The vehicle includes a vehicle body 11, a plurality of doors 12 disposed at two sides of the vehicle body 11, and a plurality of pivot units 13 each connecting a respective one of the doors 12 pivotally to the vehicle body 11. Each of the doors 12 has an outer surface and a door handle 14 disposed at the outer surface.

The collision avoidance device includes a plurality of sensing modules 2, a plurality of damping modules 3, and a control unit 4. The sensing modules 2 are disposed at the doors 12, respectively, and the damping modules 3 are connected to the pivot units 13, respectively. Cooperation among the control unit 4, one of the sensing modules 2 and a corresponding one of the damping modules 3, which is connected to the pivot unit 13 connected to the door 12 where said one of the sensing modules 2 is disposed, is the same. Therefore, only one of the sensing modules 2, a corresponding one of the damping modules 3, a corresponding one of the doors 12 and a corresponding one of the pivot units 13 are described in the following for the sake of brevity.

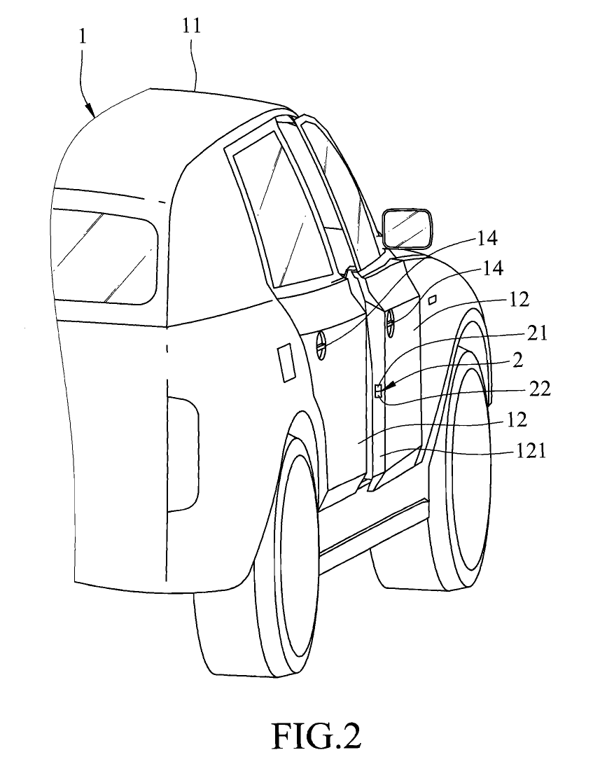

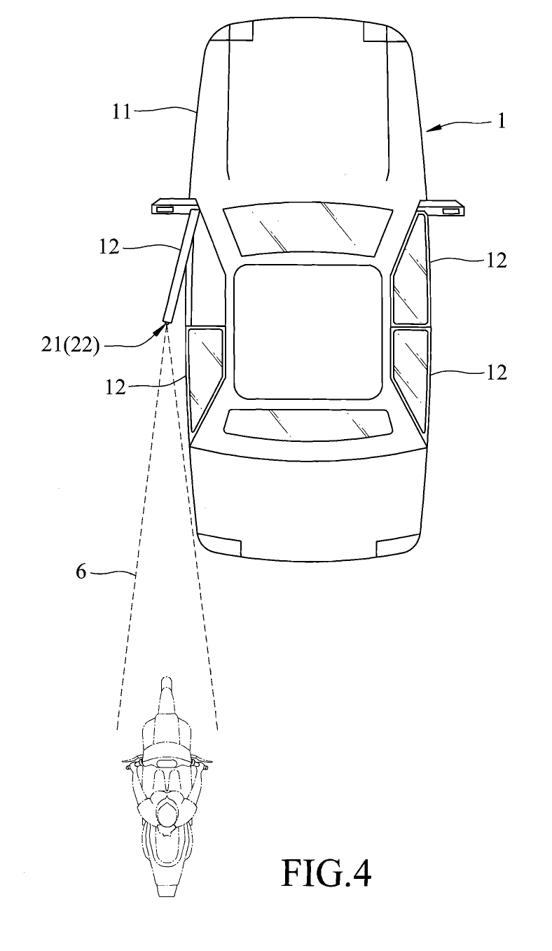

The sensing module 2 includes an infrared sensor 21, an ultrasound sensor 22 and a capacitive sensor 23. The infrared sensor 21 is disposed at a rear surface 121 of the door 12 facing a rear side of the vehicle body 11, and is operable to output a door-opened signal (M1) when the door 12 is opened (see FIG. 2), and to output a door-closed signal (M2) when the door 12 is closed. The ultrasound sensor 22 is disposed at the rear surface 121 of the door 12, and has a sensing range 6 (see FIG. 4). The ultrasound sensor 22 is operable to, upon detecting an object moving toward the door 12 in the sensing range 6 thereof, calculate a velocity of the object and output a velocity signal (S) indicating the velocity of the object. In detail, the ultrasound sensor is operable to sense a moving distance of the object in a first predetermined duration (T1), and to calculate the velocity of the moving object according to the moving distance and the first predetermined duration (T1).

The capacitive sensor 23 is disposed on an inner surface of the outer door handle 14 of the door 12, and is operable to output a touch signal (M3) upon being touched by a human. In other embodiments, the capacitive sensor 23 may be disposed at an inner door handle of the door 12.

The damping module 3 includes a motor 33, a driving gear 32 and a driven gear 31. The motor 33 has a motor shaft 331. The driving gear 32 is connected to and driven by the motor shaft 331. The driven gear 31 is connected to the pivot unit 13, and meshes with the driving gear 32. The damping module 3 is operable to apply one of a first resistance force and a second resistance force greater than the first resistance force to the pivot unit 13. In particular, the motor 33 is operable to idle the motor shaft 331 so as to not apply the first and second resistance forces to the pivot unit 13, to rotate the motor shaft 331 at a first angular speed to drive the driving gear 32 that subsequently drives the driven gear 31 for applying the first resistance force to the pivot unit 13, or to rotate the motor shaft 331 at a second angular speed slower than the first angular speed to drive the driving gear 32 that subsequently drives the driven gear 31 for applying the second resistance force to the pivot unit 13.

The control unit 4 is electrically connected to the infrared sensor 21, the ultrasound sensor 22 and the capacitive sensor 23 of the sensing module 2 for receiving the door-opened signal (M1), the door-closed signal (M2), the velocity signal (S) and the touch signal (M3), and is further electrically connected to the motor 33 of the damping module 3. The control unit 4 is operable to obtain the velocity of the object moving in the sensing range 6 according to the velocity signal (S), to compare the velocity of the object with a predetermined value, and to control operation of the damping module 3. Furthermore, for each of the damping modules 3, when the control unit 4 does not receive the door-opened signal (M1) from the corresponding one of the sensing modules 2, or receives the door-opened signal (M1) for a second predetermined duration (T2) which is longer than the first predetermined duration (T1), or receives the touch signal (M3), the control unit 4 controls the damping module 3 such that the damping module 3 does not apply the first and second resistance forces to the pivot unit 13.

It should be noted that the infrared sensor 21 and the an ultrasound sensor 22 of the sensing module 2 are disposed at the vehicle 1 to face the rear side of the vehicle body 11, for example, at an outside mirror, a rear part of the vehicle body 11, etc., but the arrangement thereof is not limited to the disclosure. Furthermore, the sensing module 2 is waterproof, and the control unit 4 and the sensing module 2 are powered by a battery of the vehicle 1 when the vehicle 1 is not started.

Referring to the FIGS. 1, 4, and 5, a collision avoidance method for avoiding collision with an object in a door zone of the vehicle 1 is implemented by the collision avoidance device, and includes the following steps.

In step 51, the control unit 4 determines whether the door-opened signal (M1) is received from the infrared sensor 21 of any one of the sensing modules 2. The flow goes to step 52 when the control unit 4 determines that the door-opened signal (M1) is received from the infrared sensor 21 of a transmitting one of the sensing modules 2 which is disposed at an opened one of the doors 12, and step 51 is repeated when otherwise. Furthermore, when the control unit 4 does not receive the door-opened signal (M1) from the infrared sensor 21 of any one of the sensing modules 2, the control unit 4 controls the damping module 3 such that the damping module 3 does not apply the first and second resistance forces to the pivot unit 13 that is connected to the opened one of the doors 12.

In step 52, the control unit 4 determines whether the touch signal (M3) is received from the capacitive sensor of the transmitting one of the sensing modules 2. When the control unit 4 receives the touch signal (M3) from the capacitive sensor 23, which is disposed at the outer door handle 14 of the opened one of the doors 12, it means that the opened one of the doors 12 is opened from the outside, and the flow goes to step 54. The flow goes to step 53 when otherwise.

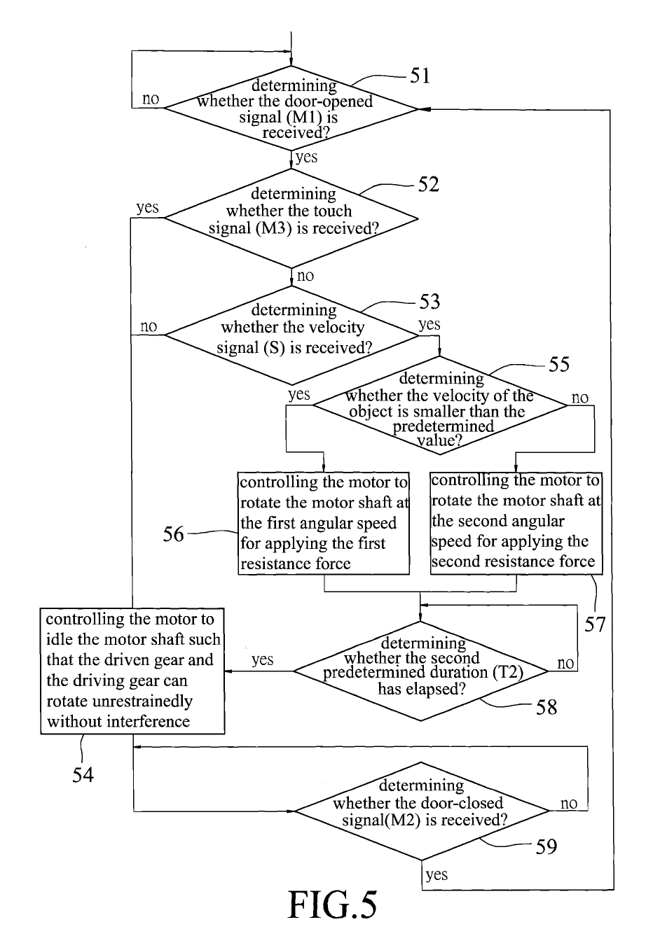

It should be noted that, in the case where the capacitive sensor 23 is disposed at the inner door handle, the determination result is opposite to step 52 in FIG. 5. Namely, when the control unit 4 receives the touch signal (M3) from the capacitive sensor 23, which is disposed at the inner door handle 14 of the opened one of the doors 12, it means that the opened one of the doors 12 is opened from the inside, and the flow goes to step 53. The flow goes to step 54 when otherwise.

In step 53, the control unit 4 determines whether the velocity signal (S) is received from the ultrasound sensor of the transmitting one of the sensing modules 2. The flow goes to step 55 when the determination is affirmative, and goes to step 54 when otherwise.

In step 54, the control unit 4 controls the motor 33 of a corresponding one of the damping modules 3 to idle the motor shaft 331 such that the driven gear 31 and the driving gear 32 can rotate unrestrainedly without interference. As a result, the corresponding one of the damping modules 3 will not apply the first and second resistance forces to the pivot unit 13 for enabling the opened one of the doors 12 to rotate at most at the initial rotational speed without interference from the corresponding one of the damping modules 3. Then, the flow goes to step 59.

In step 55, the control unit 4 obtains the velocity of the object moving in the sensing range 6 according to the velocity signal (S), and determines whether the velocity of the object is smaller than the predetermined value. The flow goes to step 56 when the determination is affirmative, and goes to step 57 when otherwise.

In step 56, the control unit 4 controls the motor 33 of the corresponding one of the damping modules 3 to rotate the motor shaft 331 at the first angular speed for applying the first resistance force to the pivot unit 13. As a result, the opened one of the doors 12 can be rotated at most at a first rotational speed slower than the initial rotational speed. Then, the flow goes to step 58.

In step 57, the control unit 4 controls the motor 33 of the corresponding one of the damping modules 3 to rotate the motor shaft 331 at the second angular speed for applying the second resistance force to the pivot unit 13. As a result, the opened one of the doors 12 can be rotated at most at a second rotational speed slower than the first rotational speed. Then, the flow goes to step 58.

In step 58, the control unit 4 determines whether the second predetermined duration (T2) has elapsed after receiving the door-opened signal (M1). The flow goes to step 54 when the determination is affirmative, and step is repeated when otherwise. It should be noted that the second predetermined duration (T2) is longer than a time length required to completely open the opened one of the doors 12 by the slowest rotational speed (i.e., the second rotational speed), such that there is no resistance force applied to the pivot unit 13 when the opened one of the doors 12 is rotated to close.

In step 59, the control unit 4 determines whether the door-closed signal (M2) is received from the infrared sensor 21 of the transmitting one of the sensing modules 2. The flow goes back to step 51 when the determination is affirmative, and step 59 is repeated when otherwise.

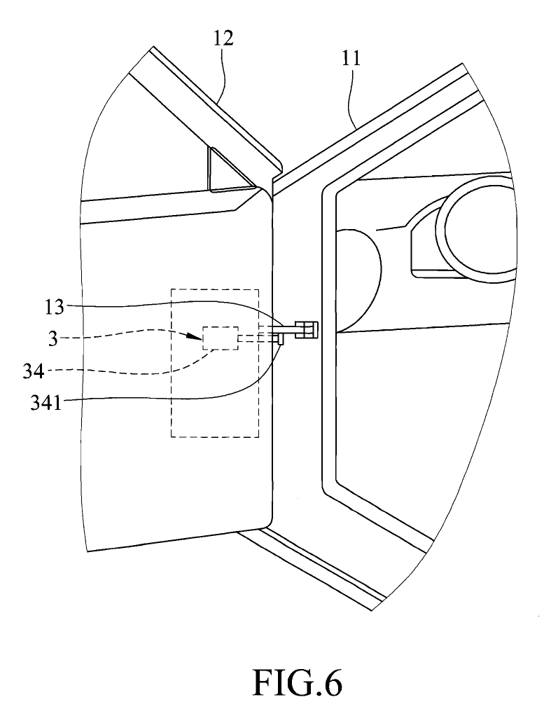

FIG. 6 is a schematic diagram for illustrating another embodiment of the damping module 3. In this embodiment, the damping module 3 includes a dashpot 34 and a connecting rod 341. The connecting rod 341 is connected to the pivot unit 13 and the dashpot 34, and is extendable with respect to the dashpot 34. The control unit 4 is operable to control fluid flow of the dashpot 34 so as to adjust extension speed of the connecting rod 341 with respect to the dashpot 34. In particular, the control unit 4 controls the dashpot 34 such that the dashpot 34 does not resist extension of the connecting rod 341 so as to not apply resistance force to the pivot unit 13, to resist the extension of the connecting rod 341 with a first friction so as to restrict the connecting rod 341 to extend at most at a first linear speed for applying the first resistance force to the pivot unit 13, and to resist the extension of the connecting rod 341 with a second friction so as to restrict the connecting rod 341 to extend at most at a second linear speed for applying the second resistance force to the pivot unit 13. The second friction is greater than the first friction, and the second linear speed is slower than the first linear speed.

In summary, by detecting the velocity of the object moving toward the door 12 in the sensing range 6, the collision avoidance device restricts rotation of the door 12 to the first rotational speed when the velocity of the object is slower than the predetermined value, and to the second rotational speed, which is slower than the first rotational speed, when the velocity of the object is faster than the predetermined value. Accordingly, the door 12 can still be opened without affecting the object, and thus, a user may not feel inconvenient and a sudden stop during opening of the door 12, and there is no impact force applied to the pivot unit 13 or the door 12. Since the collision avoidance device can adjust the rotational speed of the door 12 according to the velocity of the object, collision between the door 12 and the object can be avoided.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A collision avoidance device for avoiding collision with an object in a door zone of a vehicle, the vehicle including a vehicle body, a door disposed at one side of the vehicle body, and a pivot unit connecting the door pivotally to the vehicle body, said collision avoidance device comprising:
a sensing module configured to be disposed at the vehicle, and being operable to
output a door-opened signal when the door is opened, and
upon detecting an object moving toward the door in a sensing range thereof, calculate a velocity of the object and to output a velocity signal indicating the velocity of the object;
a damping module configured to be disposed at the vehicle, and being operable to apply one of a first resistance force and a second resistance force greater than the first resistance force to the pivot unit; and
a control unit electrically connected to said sensing module and said damping module, and being operable to
control said damping module such that said damping module does not apply the first and second resistance forces to the pivot unit for enabling the door to rotate at most at an initial rotational speed without interference from said damping module when said control unit receives only the door-opened signal from said sensing module,
control said damping module to apply the first resistance force to the pivot unit for enabling the door to rotate at most at a first rotational speed slower than the initial rotational speed when said control unit receives the door-opened signal and the velocity signal from said sensing module and determines that the velocity of the object is smaller than a predetermined value according to the velocity signal, and
control said damping module to apply the second resistance force to the pivot unit for enabling the door to rotate at most at a second rotational speed slower than the first rotational speed when said control unit receives the door-opened signal and the velocity signal from said sensing module and determines that the velocity of the object is greater than the predetermined value according to the velocity signal.

2. The collision avoidance device as claimed in claim 1, wherein said sensing module includes an infrared sensor that is configured to be disposed at a rear surface of the door facing a rear side of the vehicle body, and that is operable to output the door-opened signal when the door is opened.

3. The collision avoidance device as claimed in claim 1, wherein said sensing module includes an ultrasound sensor that is configured to be disposed at a rear surface of the door facing a rear side of the vehicle body, that has the sensing range, and that is operable to sense a moving distance of the object in a predetermined duration, to calculate the velocity of the object according to the moving distance and the predetermined duration, and to output the velocity signal.

4. The collision avoidance device as claimed in claim 1, the vehicle further including an outer door handle disposed at an outer surface of the door,
wherein said sensing module further includes a capacitive sensor that is configured to be disposed at the outer door handle and that is operable to output a touch signal upon being touched by a human,
wherein said control unit is further operable to control said damping module such that said damping module does not apply the first and second resistance forces to the pivot unit upon receiving the touch signal from said capacitive sensor.

5. The collision avoidance device as claimed in claim 1, wherein said damping module includes a motor having a motor shaft, a driving gear connected to and driven by said motor shaft, and a driven gear configured to be connected to the pivot unit and meshing with said driving gear,
wherein said control unit is operable to control said motor to
idle said motor shaft,
rotate said motor shaft at a first angular speed to drive said driving gear that subsequently drives said driven gear for applying the first resistance force to the pivot unit, and
rotate said motor shaft at a second angular speed slower than the first angular speed to drive said driving gear that subsequently drives said driven gear for applying the second resistance force to the pivot unit.

6. The collision avoidance device as claimed in claim 1, wherein said damping module includes a dashpot, and a connecting rod that is configured to be connected to the pivot unit, that is connected to said dashpot, and that is extendable with respect to said dashpot,
wherein said control unit is operable to control said dashpot
such that said dashpot does not resist extension of said connecting rod,
to resist extension of said connecting rod with a first friction so as to restrict said connecting rod to extend at most at a first linear speed for applying the first resistance force to the pivot unit, and
to resist extension of said connecting rod with a second friction so as to restrict said connecting rod to extend at most at a second linear speed for applying the second resistance force to the pivot unit, the second friction being greater than the first friction, the second linear speed being slower than the first linear speed.

7. The collision avoidance device as claimed in claim 1, wherein said control unit is further operable to control said damping module such that said damping module does not apply the first and second resistance forces to the pivot unit when a predetermined duration has elapsed.

8. A collision avoidance method for avoiding collision with an object in a door zone of a vehicle, the vehicle including a vehicle body, a door disposed at one side of the vehicle body, and a pivot unit connecting the door pivotally to the vehicle body, said collision avoidance method comprising the steps of:
a) determining whether the door is opened;
b) when the door is opened, detecting whether there is an object moving toward the door;
c) when it is determined in step b) that there is no object moving toward the door, enabling the door to rotate at most at an initial rotational speed without interference;
d) when it is determined in step b) that there is an object moving toward the door, detecting a velocity of the object;
e) determining whether the velocity of the object is smaller than a predetermined value;
f) when it is determined in step e) that the velocity of the object is smaller than the predetermined value, enabling the door to rotate at most at a first rotational speed that is slower than the initial rotational speed; and
g) when it is determined in step e) that the velocity of the object is not smaller than the predetermined value, enabling the door to rotate at most at a second rotational speed that is slower than the first rotational speed.

9. The collision avoidance method as claimed in claim 8, wherein, in step f), a first resistance force is applied to the pivot unit for enabling the door to rotate at most at the first rotational speed, and in step g), a second resistance force that is greater than the first resistance force is applied to the pivot unit for enabling the door to rotate at most at the second rotational speed.

10. The collision avoidance method as claimed in claim 8, wherein step d) includes the sub-steps of sensing a moving distance of the object in a predetermined duration, and calculating the velocity of the object according to the moving distance and the predetermined duration.

11. The collision avoidance method as claimed in claim 8, the vehicle further including an outer door handle disposed at an outer surface of the door, wherein said collision avoidance method further comprises the steps of:
determining whether the door is opened by using the outer door handle;
when it is determined that the door is opened by using the outer door handle, enabling the door to rotate at most at the initial rotational speed without interference; and
when it is determined that the door is opened not by using the outer door handle, implementing step b).

12. The collision avoidance method as claimed in claim 8, further comprising the steps of:
determining whether a predetermined duration has elapsed;
when it is determined that the predetermined duration has elapsed, enabling the door to rotate at most at an initial rotational speed without interference and determining whether the door is closed; and
repeating step a) when the door is closed.

13. The collision avoidance method as claimed in claim 8, further comprising the steps of determining whether the door is closed, and repeating step a) when the door is closed.
